(19) United States
(12) Patent Application Publication
(10) Pub. No.: US 2009/0219151 A1
(43) Pub. Date: Sep. 3, 2009

(54) ERGONOMIC AND EXTENSIBLE SUPERVISION SYSTEM USING DATA OF A COMPUTERIZED PLAN

(75) Inventors: Carlos Moreno, Chateau Landon (FR); Yu Liu, Ferriere (FR); Stephane Belot, Longueville (FR)

Correspondence Address: PERMAN & GREEN, 425 POST ROAD, FAIRFIELD, CT, 06824, US

(73) Assignee: SINOVIA, Evry (FR)

(21) Appl. No.: 11/997,152

(22) PCT Filed: Jul. 26, 2005
(86) PCT No.: PCT/FR05/50621

§ 371 Date: Jul. 31, 2008

(51) Int. Cl. G08B 29/00

(52) U.S. Cl. 340/506

(57) ABSTRACT

An ergonomic and extensible supervision system, in particular for technical management of buildings, centralized technical management and fire safety, using data of at least one computerized plan representing the installation to be supervised and the technical elements of the installation and including: an automatic computer-based reading component for analyzing and extracting data from the plan in the form of blocks containing at least one technical element; a computer-based viewing component for generating, from the data supplied by the reading component, and data concerning the technical elements, a list of variables and data corresponding to the blocks, including the mapping data of the technical elements; a computer-based matching component for matching the list of variables with the technical elements located in the installation to be monitored, so as to constitute a supervising application; means for parametering the supervising application, using a man/machine interface.

### CROSS REFERENCE TO RELATED APPLICATIONS

This application is the National Stage of International Application No. PCT/FR2005/050621, International Filing Date, 26 Jul. 2005, which designated the United States of America, and which International Application was published under PCT Article 21 (2) as WO Publication No. WO2007/012708, the disclosures of which is incorporated herein by reference in its entirety.

### BACKGROUND

1. Field

The disclosed embodiments relate to an ergonomic and extensible supervision system, in particular intended for the technical management of buildings, centralized technical management and fire safety, this system implementing the information of a computerized plan.

2. Brief Description of Related Developments

Centralized technical management (CTM) is a set of tools and procedures intended to ensure the management, tracking and monitoring of technical installations, in particular very heterogeneous and complex installations. In BTM/CTM, safety covers a wide spectrum of applications such as: management of alarms in buildings or production sites, protection and monitoring of protected or dangerous areas, detection of equipment failure, detection of fires, dangerous radiations, power supply outages, or intrusion. The known management systems are very specific systems dependent on the type of installation to be supervised. This poses problems in regard to design time, since for each installation it is necessary to develop and roll out a system taking account of the characteristics of the installation and of its technical elements. Furthermore, these systems do not make it possible to easily perform updates such as adding or removing a technical element of the installation, since each time it is necessary to stop the application, and pass through a programming step to integrate the new elements. This of course poses a problem at the system use level, since the intervention of a person having computing skills is necessary in order to perform each update.

### SUMMARY

The disclosed embodiments are aimed at remedying at least one of these drawbacks.

The disclosed embodiments relate to an ergonomic and extensible supervision system, in particular intended for the technical management of buildings, centralized technical management and fire safety, implementing the information of at least one computerized plan representing the installation to be supervised and technical elements of this installation and comprising:

a computer-based automatic reading component making it possible to analyze and to extract the information from the plan in the form of blocks containing at least one technical element,

a computer-based viewing component making it possible to generate, on the basis of the information provided by the reading component, and of data relating to the technical elements, a list of variables and data corresponding to the blocks, comprising the cartographic coordinates of the technical elements,

a computer-based matching component making it possible to match up the list of variables with technical elements situated in the installation to be monitored, so as to constitute a supervision application, and

means for parametrizing the supervision application, implementing a man/machine interface.

This system makes it possible to supervise an installation represented by a computerized plan. Specifically, the system makes it possible to obtain in real time information on the state of the system and of its technical elements that it comprises. The integration of new technical elements, that is to say the updates of the application, are made in an automatic manner, as described further on. The computerized plan arises from computer-aided design software, for example software of Autocad® type.

According to a realization, the man/machine interface comprises tools for managing the plans read by the computer-based reading component, in particular a tool for enlarging images.

Among these tools for managing plans is also a tool making it possible to take into account the hierarchy of the plans, and thus to manage the passage from one plan to another. This hierarchization is used during an image enlargement request, since this enlargement consists in fact in passing to a more accurate plan of an area of the installation.

According to a realization, the data relating to the technical elements are included in the group comprising: the network addresses of the technical elements in a network covering the installation, technical characteristics of these elements and data relating to the operating state of these elements.

The network addresses make it possible to locate the technical elements in a computer-based network which links the various elements of the installation. The technical characteristics are for example the type of an element (a door, a sensor) and certain indications about the operation thereof. The data relating to the operating state can for example be data with two states of the “open” and “closed” type, or data with three states of the “in service”, “out of service” and “faulty” type.

According to a realization, the system comprises a computer-based alarm component for signaling the malfunction of a technical element, on the basis of data relating to this element.

This component makes it possible to signal that one of the technical elements of the installation has passed to an abnormal operating state, for example that a door is open though it ought not to be, or that a sensor is faulty.

According to a realization, the man/machine interface comprises a tool for viewing the alarms provided by the computer-based alarm component.

Upon the triggering of an alarm by the computer-based alarm component, the tool for viewing the alarms makes it possible to provide a visual alert on a screen, so as to forewarn the operators in charge of monitoring the installation. This viewing tool also makes it possible to associate a behavior with certain technical elements, for example in the form of a gauge or of an open or closed door.

According to a realization, the man/machine interface comprises a tool for archiving the alarms provided by the computer-based alarm component.

This tool makes it possible to log the alarms and to class them as a function of a chosen criterion, for example by date, by type of equipment, by area in the installation. This tool can allow, for example, statistical calculations to be made subsequently so as to improve the installation.

According to a realization, the technical elements are of alarm, communication or equipment type.

The elements of equipment type are for example doors. Specifically, it may be necessary to supervise them so as to verify their state, namely open or closed.

According to a realization, the computer-based components are integrated and managed by an open system comprising a core comprising:

a standard context for integrating the computer-based components into the supervision and control application,

an integration protocol, common to the components, comprising instantiation and loading means intended to catalogue, select and assign the computer-based components to the realization of functional objectives of the determined application, and

connection means intended to establish connections and to monitor message flows between the computer-based components.

This realization is based on a software tool allowing easy design of distributed applications on the basis of heterogeneous software components. This software tool is in fact an open environment for integrating and managing components distributed within one and the same machine or between several machines connected to a TCP/IP Ethernet network. This software itself relies on a core which offers all the basic services necessary for the management of components, their recording, their instantiation and their representation. The core also affords the communication medium between the components and manages their connections.

### BRIEF DESCRIPTION OF THE DRAWINGS

Other characteristics and advantages of the disclosed embodiments will be apparent with some of these embodiments, which will be described on the basis of the figures in which:

FIG. 1 represents a scenario of use of a system in accordance with the disclosed embodiments,

FIG. 2 represents a man/machine interface in accordance with the disclosed embodiments, and

FIG. 3 represents the open system for integrating the components in accordance with the disclosed embodiments.

### DETAILED DESCRIPTION OF THE DRAWINGS

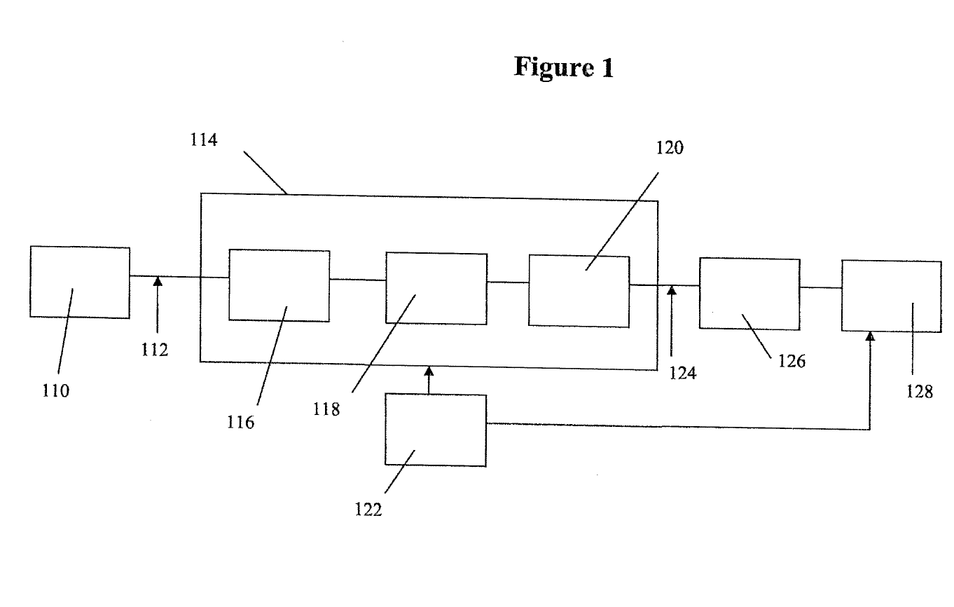

FIG. 1 represents a scenario of use of a system according to the disclosed embodiments, with the various steps constituting the supervision of an installation.

A plan 110 is available which represents the installation, that is to say the buildings and technical elements to be supervised. On an action 112 by the user, the plan is loaded into the system so as to be processed therein. The user action consists in giving the loading order, but may also consist in providing, in the form of a description file, data relating to the technical elements, for example their network addresses or variables representing their operating state.

The system is then in an initialization phase 114. The plan is first of all read by the automatic reading component 116, which extracts the information in the form of blocks containing the technical elements to be supervised. Thereafter, the system generates, through the intermediary of a viewing component 118, a list of variables and data corresponding to the technical elements. This list can, for example, contain the type of the elements, their location, a variable field representing their state, or else their network address, that are obtained in particular during the user action 112.

Once this list has been created, a matching with the technical elements physically present in the installation to be supervised is performed. Additionally available are parametrization means, implementing a man/machine interface 122, in particular making it possible to view the plan on a screen.

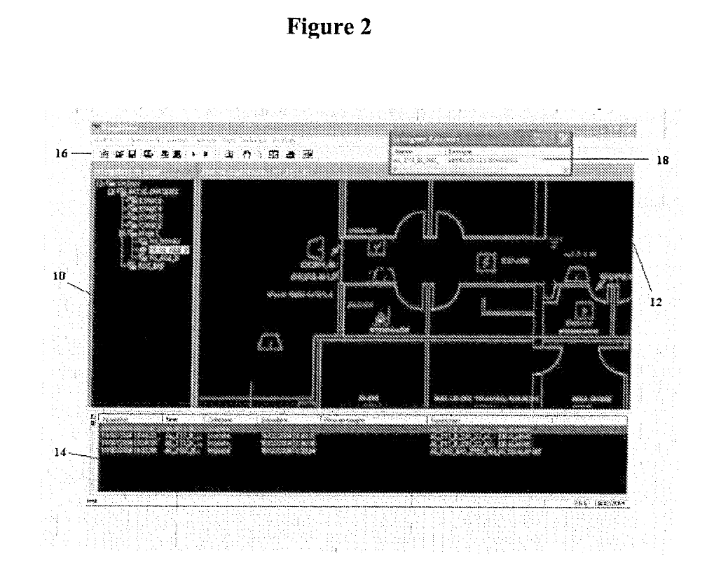

Once this initialization phase 114 has been performed, the system is then ready to actually supervise the installation. When a malfunction event 124 occurs, the alarm component 126 provides an alarm to signal this malfunction. The man/machine interface 122 then makes it possible to view this alarm on the plan 128 in the form of a visual alert. The user can then choose, also through the intermediary of the interface 122, to perform an image enlargement on the defective area. Moreover, as a function of the parameters chosen by the user, this alarm may be archived with certain information relating to it. This point will be detailed with the aid of FIG. 2.

When the user wishes to integrate a new technical element into the installation to be supervised, he provides a computerized plan containing this technical element, and he also provides data relating to this element. He then merely has to restart the process through a new action 112 so that this element is taken into account. This update presents the advantage of being automatic, and of not requiring the application to be stopped, since no programming is needed to integrate this new element. It suffices to load the data relating to the technical element. This makes it possible to perform continuous supervision, and does not require any particular computing skills from users.

FIG. 2 represents a man/machine interface used for the supervision of a building comprising five stories. This interface comprises three windows 10, 12 and 14, as well as a toolbar 16 containing the various icons usable by the operator. The window 10 contains a browser making it possible to navigate through the various plans representing the building. This browser takes the form of a tree of files, each file representing a plan. The highest files in the tree represent the assembly plans. In this window, the file used is highlighted by a white banner over the name. The plan represented by this file is viewed in the window 12. In this window 12 appears the plan of the wing B of level 1 of the building, as well as the various technical elements to be monitored. All the alarms relating to this part of the building are displayed in the window 14. In this window, the alarms are displayed with certain description elements making it possible to analyze them, such as the type of alarm or the date of occurrence. The user can choose to peruse the details of an alarm, view a directive associated with this alarm in a new window 18 or else to acknowledge it. He can also choose to archive it in a file, for example to perform statistical calculations on the alarms which are triggered in the installation, and thus improve the supervision. The man/machine interface also comprises a toolbar 16 containing buttons and pop-up menus making it possible to carry out various operations such as the loading of a plan, backups, configuration, image enlargements, or printouts.

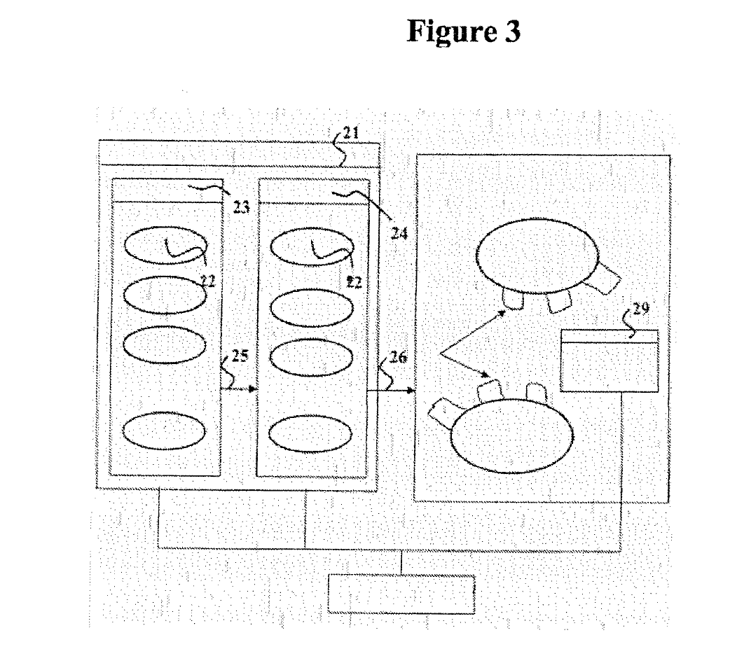

FIG. 3 illustrates the computer-based components integration and management open system which can be used with the disclosed embodiments. The role of this system is to integrate the various computer-based components 22, which comprise, according to a realization of the disclosed embodiments, a plan reading component, a viewing component and an alarm component. For this purpose, the components manager 21 creates a list of component classes 23 and a list of component instances 24. The list of classes 23 contains the descriptive information and the location of the various components to be integrated. The list of instances 24 contains the instances of components currently being executed. Additionally, this components manager 21 handles the components loading and instantiation operations 25, that is to say their registration in the guise of objects belonging to a particular class of components, as well as the selection 26 of the components. Finally the system has a connections list containing the various interconnections existing between the components.

1. An ergonomic and extensible supervision system, in particular intended for the technical management of buildings, centralized technical management and fire safety, implementing the information of at least one computerized plan representing the installation to be supervised and technical elements of this installation and comprising:
a computer-based automatic reading component making it possible to analyze and to extract the information from the plan in the form of blocks containing at least one technical element,
a computer-based viewing component making it possible to generate, on the basis of the information provided by the reading component, and of data relating to the technical elements, a list of variables and data corresponding to the blocks, comprising the cartographic coordinates of the technical elements,
a computer-based matching component making it possible to match up the list of variables with technical elements situated in the installation to be monitored, so as to constitute a supervision application, and
means for parametrizing the supervision application, implementing a man/machine interface.

2. The system as claimed in claim 1 in which the man/machine interface comprises tools for managing the plans read by the computer-based reading component, in particular a tool for enlarging images.

3. The system as claimed in claim 1 in which the data relating to the technical elements are included in the group comprising: the network addresses of the technical elements in a network covering the installation, technical characteristics of these elements and data relating to the operating state of these elements.

4. The system as claimed in claim 3 comprising a computer-based alarm component for signaling the malfunction of a technical element, on the basis of data relating to this element.

5. The system as claimed in claim 4 in which the man/machine interface comprises a tool for viewing the alarms provided by the computer-based alarm component.

6. The system as claimed in claim 4 in which the man/machine interface comprises a tool for archiving the alarms provided by the computer-based alarm component.

7. The system as claimed in claim 1 in which the technical elements are dedicated components of alarm, communication or equipment type.

8. The system as claimed in claim 1 in which the computer-based components are integrated and managed by an open system comprising a core comprising:
a standard context for integrating the computer-based components into the supervision and control application,
an integration protocol, common to the components, comprising instantiation and loading means intended to catalogue, select and assign the computer-based components to the realization of functional objectives of the determined application, and
connection means intended to establish connections and to monitor message flows between the computer-based components.
